(19) United States
(12) Patent Application Publication
(10) Pub. No.: US 2011/0100061 A1
(43) Pub. Date: May 5, 2011

(54) Formation of microstructured fiber preforms using porous glass deposition

(76) Inventors: James Fleming, Westfield, NJ (US); George Zydzik, Columbia, NJ (US)

(21) Appl. No.: 12/589,951

(22) Filed: Oct. 30, 2009

(51) Int. Cl. C03B 37/018

(52) U.S. Cl. 65/391

(57) ABSTRACT

A method of making a microstructured optical fiber preform uses the plasma fusion of a powder layer deposited onto a substrate under conditions that prevent the deposited layer from completely densifying, thereby yielding the formation of bubbles within the layer. By systematic control of powder melt and delivery, while maintaining the process temperature below a temperature associated with densifying the deposited layer, the powder particles densify only partially on the substrate and create bubbles of a fairly narrow (and thus controllable) diameter range within a defined region of the preform. Upon drawing a fiber from the preform, the bubbles will extend into gas lines, forming a desired microstructure arrangement.

### TECHNICAL FIELD

The present invention relates to the formation of a microstructured fiber preform and, more particularly, forming a microstructured fiber preform by applying plasma fusion to a layer of powder deposited onto an outer surface of an optical fiber substrate under certain conditions that prevent the deposited layer from completely densifying, thereby yielding the formation of bubbles within the layer to create a microstructured arrangement.

### BACKGROUND OF THE INVENTION

There are numerous potential applications for microstructured optical fiber, also known as “holey fibers”. The inclusion of air-filled (more generally, gas-filled) holes in solid glass lowers the effective index of the glass and/or creates band gaps affecting light propagation. Therefore, these “holey” glass materials can function as a cladding of an optical fiber. There are several known methods of making such a fiber. Most rely on systematic assembly and draw of stacked rods and tubes, or casting sol-gel bodies having holes of the desired geometry. These methods work well, and are particularly useful where precise orientation of the holes is important—such as in the case of photonic crystal fiber.

However, there are certain applications that do not require such precision in the air/gas hole orientation, yet may benefit from the index modifications attributed to the inclusion of such structures in an optical fiber, particularly in the cladding region of the fiber. Thus, a flexible, low cost method for introducing microstructures in these fibers is desired.

One current method of creating random arrays of holes in optical fiber includes injecting gas into a fluid during fiber draw. The gas forms bubbles that are thereafter drawn into long, microscopic holes. The gas is generally created by vaporized nitride or carbide compounds. Another current method includes creating a microstructured fiber by depositing glass soot and then consolidating the soot under conditions which are effective to trap a portion of the gasses in the glass, thereby creating a non-periodic array of holes which may then form a microstructured cladding region of a drawn fiber. Yet another current method depicts pouring a bubble creating” slurry containing amorphous silica particles into an annular space between an external cladding layer and a concentric core rod, gelling the slurry to produce a material which forms bubbles by means of a subsequent thermal treatment.

Drawbacks associated with such methods include such non-controllability of the location and size of the holes within the cladding layer that the effective index of the cladding layer may become too variable as a function of preform or fiber position.

### SUMMARY OF THE INVENTION

The needs remaining in the above and other methods are addressed by the present invention, which relates to the formation of a microstructured fiber preform and, more particularly, to the use of plasma fusion of a silica powder layer deposited onto an outer surface of an optical fiber substrate, such as a bait rod, a preform core rod, a tube, and the like. The powder layer is deposited under conditions that prevent the deposited layer from completely densifying, thereby yielding the formation of bubbles within the deposited layer. As used herein, the term “bubble” is defined as air or gas encapsulated within the surrounding glass to form a partially-densified layer. By proper selection of the particle size distribution of the powder and the processing conditions, the bubbles are substantially uniform in size and spacing within the layer.

In accordance with the present invention, the temperature of the plasma fusion process is kept below that associated with complete densification of the deposited powder, which allows for molten powder particles to fuse together on the outer substrate surface to create bubbles of a narrow diameter range. Indeed, the control of the plasma fusion process temperature allows for fabrication of bubbles that will evolve into gas lines of preferred sizes during a fiber draw process, where the phrase “gas line”, as used hereinafter, represents elongation of a bubble during the fiber draw process. The line may comprise an air line or gas line, depending on the parameters of the process, but will be referred to as a “gas line” for the sake of expediency. Further, the size of the bubbles can be controlled by a combination of parameters, including (but not limited to) powder composition, particle size within the powder, plasma conditions, preform substrate size, plasma gas composition and plasma traverse speed over the substrate. Moreover, the size and shape of the gas lines can be controlled in accordance with the present invention by the properties of the bubbles and the conditions applied to the preform during fiber draw (the latter including, for example, draw temperature, draw speed, and temperature distribution along the preform and drawn fiber).

One advantage of this method of the present invention is that the bubbles can be formed at plasma fusion process temperatures within the range of conventional fiber draw temperatures. By keeping the plasma fusion process temperature in this range while controlling other parameters, such as the powder composition, particle size, and the like, the bubbles are prevented from collapsing, expanding or joining with other bubbles later during the fiber drawing process. However, to prevent excessive bubble growth during fiber draw, the resulting fiber should not be drawn above a temperature that substantially exceeds the plasma fusion process temperature.

In accordance with the present invention, the bubbles within the deposited layer can be converted into extended gas lines during fiber draw while maintaining substantially the same ratio (with respect to the drawn fiber) as present in the original preform (i.e., “gas line diameter:fiber diameter” is substantially the same as “bubble diameter:preform diameter”). The gas lines lower the effective refractive index of the silica glass region in which they reside. For certain choices of preform dimensions, bubble size and draw conditions, a fiber can be made where gas lines of a desired diameter are continuous for several hundred meters—generally associated with utilizing larger diameter bubbles. Alternatively, smaller bubbles within the deposited layer will convert into shorter gas lines that may be advantageous in affecting the optical properties of the fiber. For example, shorter gas lines can increase optical scattering in the glass and may be useful in instances where optical attenuation is desirable. These shorter gas lines can be formed by manipulation of the powder deposition process to create smaller bubbles that do not expand or contract substantially during the draw process, or be formed by controlling the draw conditions to facilitate sufficient collapse of larger bubbles, resulting in the desired gas line properties in the final drawn fiber.

Other and further advantages and details of the method of the present invention will become apparent during the course of the following discussion and by reference to the following drawings.

### BRIEF DESCRIPTION OF THE DRAWINGS

Referring now to the drawings,

FIG. 1 illustrates an exemplary apparatus for creating a microstructured optical fiber preform in accordance with the present invention;

FIG. 2 depicts an exemplary evolution of deposited powder particles into a partially densified layer including a plurality of bubbles trapped therein;

FIG. 3 is a graph of particle size distribution (normalized) as a function of particle size, as associated with the creation of essentially uniform bubble size;

FIG. 4 is a photograph of an exemplary microstructured optical fiber preform containing plasma-generated gas bubbles in accordance with the present invention;

FIG. 5 is a photograph of a drawn section of fiber, illustrating the transition of the gas bubbles into gas lines in accordance with the present invention;

FIG. 6 is a cross-sectional view of an exemplary 125 μm optical fiber including lines drawn from bubbles in accordance with the present invention, where in this case the draw conditions are controlled to maintain the ratio of the bubbles during draw; and

FIG. 7 is a cross-sectional view of another 125 μm optical fiber of the present invention, in this case subjected to a slower draw condition at a temperature greater than that applied to the fiber of FIG. 6, where a number of bubbles grow and join together to form larger and fewer gas lines.

### DETAILED DESCRIPTION

It has been found that a porous material can be deposited onto an optical fiber preform substrate to form a layer containing bubbles as part of the preform structure. By virtue of incorporating gas bubbles into a layer in the preform structure (for example, as an annular layer in the cladding structure), the effective refractive index of this layer can easily be modified, which is a useful tool in controlling the index profile of a fiber drawn from the preform. In accordance with the present invention, a powder having particles of a controlled size (for example, silica powder) is deposited onto an outer surface of a preform substrate through a plasma process. By choosing appropriate deposition conditions such as, but not limited to: (1) rotational and translational movements of the preform substrate with respect to the plasma source; (2) maintaining a temperature at a value near the fiber draw temperature; and (3) composition of the deposited powder and powder particle size, a desired size and density of the bubbles is effectively controlled. As mentioned above, the term “bubble” is defined as air or gas encapsulated within the layer being formed.

A significant feature of the preform fabrication process of the present invention is the narrow range of bubble size present in the deposited material. This feature allows the possibility of creating bubbles at a plasma fusion process temperature within the same range as that used during a conventional fiber draw process. By using a plasma fusion process temperature similar to a conventional fiber draw temperature, the bubbles will not enlarge, expand, join together or collapse during draw. Alternatively, the bubbles can be collapsed or expanded, if desired, through adjusting these two temperatures relative to one another (i.e., the plasma fusion process temperature and the fiber draw process temperature). One advantage of the fabrication process of the present invention is the ability to combine this particular bubble-creating method with conventional overcladding approaches to place the bubble-containing layer at any desired radial distance from the center of a preform substrate core region. Indeed, the process of the present invention may be used multiple times, and/or use different powder compositions/particle size to create separate overcladding layers, where each cladding layer exhibits a different refractive index by virtue of a difference in the bubble size/density between the layers.

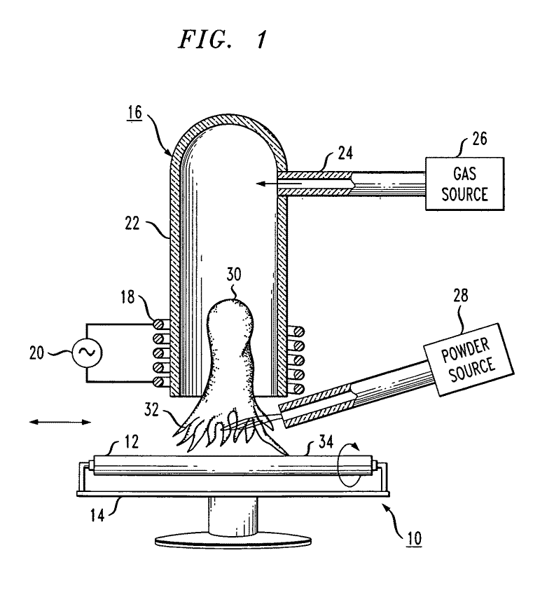

FIG. 1 shows an outline of an exemplary apparatus for creating a bubble-containing layer along an outer surface of an optical fiber preform substrate, where the substrate typically comprises a cylindrical rod or tube. A glass-working lathe 10 is mounted in a vented hood (not shown), and rotates a preform substrate 12 about a horizontal axis. In this embodiment, glass-working lathe 10 is mounted on a pedestal 14. A plasma torch 16 is suspended vertically over substrate 12 and is employed in conjunction with an RF coil 18 and associated RF generator 20 to create a plasma discharge. In this exemplary apparatus, plasma torch 16 comprises a fused silica mantle 22 connected by a tube 24 to a gas source 26 which feeds the gas desired to create a plasma discharge 30 in mantle 22. An induced field within coil 18 from RF generator 20 operating around 2-5 MHz has been found sufficient to excite the plasma. Because of the low ionization potential of argon, this is a preferable gas to be used as an initial source 26; however, other suitable gases may be used. In an exemplary arrangement, the plasma is first initiated with argon gas and is thereafter gradually shifted to a hotter oxygen or an oxygen-helium mixture from gas source 26 for deposition of the powder. A gas control system with the ability to follow computer command is preferably used in connection with a mixing manifold (not shown) for delivery to plasma torch 16.

In accordance with the present invention, a powder from a separate powder source 28 is injected into the tail region 32 of plasma discharge 30, where it melts and is deposited on outer surface 34 of substrate 12. In accordance with the present invention, the powder may comprise particles of glass or glass-forming silica material. Exemplary powders include a synthetic amorphous silica powder and a crystalline silica powder. A powder particle size in a range of, for example, approximately 15 μm to approximately 500 μm can be used.

Powder source 28 may comprise, for example, a vibratory powder feeder that continuously introduces a regulated quantity of a precursor powder into a stream of an inert gas, such as nitrogen, which carries the particles to plasma torch 16. The powder-gas stream is thus directed into tail region 32 of plasma discharge 30 to facilitate the fusion of the powder particles together onto rotating outer surface 34 of substrate 12. It is an important aspect of the present invention that the temperature of the plasma fusion process is controlled such that the powder particles melt in the plasma flame and fuse together, yet do not completely densify upon contact with outer surface 34 of substrate 12. That is, the plasma fusion process temperature must be maintained at a level lower than that associated with complete densification of the particular powder composition.

Although not specifically illustrated in FIG. 1, RF excitation oscillator 20, coil 18 and plasma torch 16 move along substrate 12 (indicated by the double-ended arrow) during deposition by means of, for example, a motor-driven support carriage (not shown). The speed of the traverse can be used to reduce the time that the deposited powder is subjected to heating and melting. A separate motor (not shown) may be used to control the vertical position of plasma torch 16 relative to substrate 12. The position of plasma torch 16 with respect to substrate 12 is also important for temperature control. As briefly mentioned above, the deposition rate and degree of powder melting depends strongly on the heat output from plasma torch 16. For example, a system limited to about 20 kW electrical power at the RF oscillator 20 can deposit silica powder at rates approaching 15 gm/min with substrate diameters around 30 mm. Scaling up both rate and diameter demands greatly increased power, since more material must be heated to the melting point—while radiative, convective and conductive heat losses increase with increasing substrate diameter. For example, a 40 mm diameter substrate could be made with the 20 kW system, but only at deposition rates below 10 grams per minute. The deposition rate is also increased by the use of a broad plasma fireball. Many plasma torch designs are acceptable for this application.

The efficiency with which the power delivered by source 28 is collected on substrate 12 has been found to be about 90% in experiments using this method of delivery to the substrate surface. However, random perturbations with regard to deposition in local regions of the preform could cause unacceptable diameter variations. Diameter control can be maintained through continuous monitoring of the plasma diameter and feedback to the deposition apparatus to control motion. Note that in the above discussion, the substrate 12 may take the form of a bait rod, a preform core rod, a tube, or any other body onto which a bubble-containing glass layer is being deposited.

As mentioned above, the present invention focuses on an intermediate state where the powder is melted, but only partially fused and partially densified. Additionally, to achieve the desired bubble size in the deposited layer, the particle size and particle size distribution are important factors. A unique quality of a microstructured fiber preform formed in accordance with the present invention is that the bubbles are created with a narrow range of diameters, allowing subsequent growth or collapse to be controlled by the relative process temperatures of bubble formation and fiber draw. In particular, if bubble formation occurs at substantially the same temperature as later used to draw the fiber, the pressure inside the bubbles will not substantially change and the drawn gas lines will exhibit essentially the same ratio (with respect to the drawn fiber) as the original bubbles exhibited with respect to the original preform. Alternatively, if the temperature during bubble formation is substantially greater (lower) than that used to draw the fiber, the bubbles will partially contract (expand).

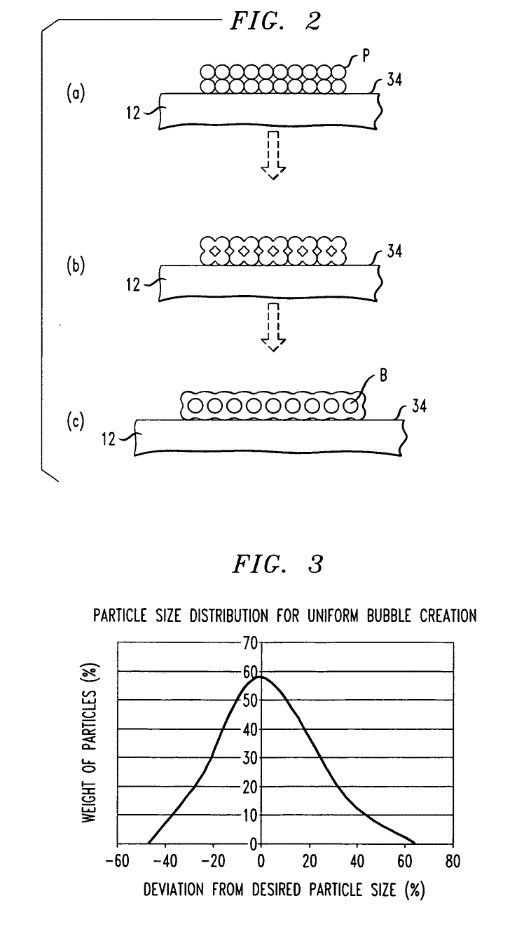

FIG. 2 depicts the evolution of deposited power particles into a partially-densified layer having gas bubbles trapped therein, in accordance with the present invention. It is to be understood that the illustrations of FIG. 2 are merely for the purpose of explanation and representations of an exemplary process. FIG. 2(a) shows a plurality of separate and distinct powder particles P which are first deposited on outer surface 34 of substrate 12. Following the deposition, the particles begin to densify and fuse together, as shown in FIG. 2(b). The rate at which this process occurs is obviously a function of the temperature at substrate 12. The densification process continues, as shown in FIG. 2(c), until the particles have partially densified so as to create discernible gas bubbles B.

As mentioned above, one parameter that may be utilized to control the size of the created bubbles is the size of the original powder particles introduced into the plasma fusion process. FIG. 3 is a graph showing the particle size distribution, normalized for the choice of the desired particle size. This particular distribution of initial power particle size was found to be effective in producing substantially uniform bubbles in the plasma fusion process of the present invention.

FIG. 4 is a photograph of an exemplary bubble-containing overcladding region formed by the plasma process of the present invention. As described above, the size and density of the bubbles are controlled by factors such as the plasma power level, the plasma-to-substrate separation and the plasma gas flow rates, as well as the composition of the powder itself (and size of the particles contained therein) and the gas composition. It is well known that gases can dissolve into or diffuse through glass at different rates depending on the chemistry of the glass and the gas composition. This effect can be used to alter the bubble and gas line size during processing. Generally speaking, the size of a bubble can vary from a few microns to a millimeter, depending on the requirements for the drawn fiber itself (e.g., cladding layer reflective index, degree of optical scattering, etc.).

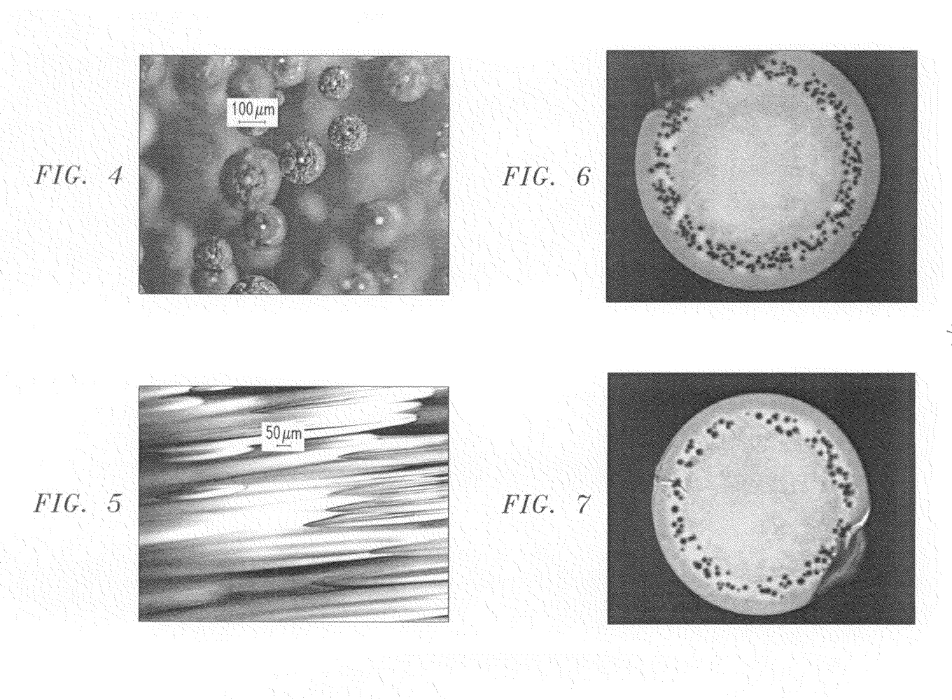

During fiber draw, the bubbles within the preform elongate into gas lines, perhaps extending several hundreds of meters. As discussed above, the “gas” lines may comprise air lines, argon gas lines, or lines of any other gaseous composition suitable in the fabrication of optical fibers. FIG. 5 is a photograph of a section of drawn fiber, showing the formation of the gas lines generated from the original bubbles. It has also been found that the draw conditions can be controlled to dictate the parameters of the gas lines. Under specific draw conditions, for example, the ratio of the bubbles' diameter to the preform diameter can be maintained during draw, resulting in a similar ratio between the gas line diameter and the drawn fiber diameter. FIG. 6 is a cross-sectional view of an exemplary optical fiber drawn down to an outer diameter of 125 μm using a draw process commonly employed for silica-based preforms. As shown, the optical fiber includes a cladding layer containing gas lines formed from the original bubbles in accordance with the present invention. It is to be noted that the particle size distribution mentioned above in association with FIG. 3 fits the particle size distribution of the powder used in the creation of the fiber shown in FIG. 6

On the other hand, when using a slower, higher temperature draw rate, it has been found that the bubbles will grow and merge, forming fewer and larger gas lines with these gas lines having a larger diameter than would otherwise be consistent with the draw feature ratio. FIG. 7 is a cross-sectional view of another optical fiber with an outer diameter of 125 μm, in this case drawn under a reduced rate condition. As evident from this photograph, the number of gas lines is reduced from the illustration of FIG. 7, with the diameters of the gas lines being larger.

It will be apparent to those skilled in the art that various modifications and variations can be made to the present invention without departing from the spirit and scope of the invention. Thus, it is intended that the present invention cover any and all of such modifications and variations, provided they come within the scope of the appended claims and all equivalents thereto.

What is claimed is:

1. A method of making a microstructured optical fiber preform, the method comprising the steps of:
a) providing a substrate of optical material;
b) creating a plasma discharge;
c) traversing the plasma discharge across a desired extent of a surface of the substrate;
d) feeding a powder into the plasma discharge such that the powder is deposited onto the substrate surface; and
e) partially densifying the deposited power to form a layer on the substrate surface, wherein the layer comprises a plurality of bubbles.

2. The method as defined in claim 1 wherein the substrate is selected from the group consisting of a bait rod, a preform core and a tube.

3. The method as defined in claim 1, wherein the substrate is made of a silica material.

4. The method as defined in claim 1 wherein the powder comprises a silica powder.

5. The method as defined in claim 4 wherein the silica powder is selected from a group consisting of: synthetic amorphous silica, silica glass and crystalline silica.

6. The method as defined in claim 1 wherein the powder comprises a particle size in the range of about 15-500 μm.

7. The method as defined in claim 6 wherein the powder comprises a particle size distribution associated with creating essentially uniform-sized bubbles.

8. The method as defined in claim 1 wherein the silica powder comprises a particle size selected to yield a specifically-sized bubble in the deposited layer.

9. The method as defined in claim 1, wherein the step of partially densifying the deposited powder occurs by maintaining a plasma fusion process temperature less than that associated with complete densification of the deposited powder.

10. The method as defined in claim 9 wherein the plasma fusion process temperature is maintained by controlling separation between the plasma discharge and the substrate.

11. The method as defined in claim 9, wherein the plasma fusion process temperature is maintained at a value near a draw temperature value.

12. The method as defined in claim 1 wherein a size of each bubble created in the layer formed on the surface of the substrate is controlled by a power level of the plasma discharge, a flow rate of the plasma discharge, and the separation between the plasma discharge and the powder-covered substrate surface.

13. The method as defined in claim 1, further comprising repeating steps c)-e) to create a plurality of bubble-containing layers, where each layer is created over a previous bubble-containing layer.

14. The method as defined in claim 13, further comprising the step of using a different powder during each series of steps c)-e), thereby creating separate bubble-containing layers, wherein each separate layer exhibits a specific effective refractive index.

15. The method as defined in claim 1, further comprising the step of:
f) drawing down the preform into an optical fiber of a defined outer diameter, wherein the plurality of bubbles transform into gas lines during the drawing down process.

16. The method as defined in claim 15 wherein step f) further comprises the step of controlling a draw rate to maintain a ratio of gas line diameter with respect to a drawn fiber diameter to be substantially the same as the original bubble diameter with respect to the preform diameter.

17. The method as defined in claim 15 wherein step f) further comprises the step of implementing a higher effective draw temperature so as to modify a bubble cross section from that initially created in step e).
